(19) United States
(12) Patent Application Publication
(10) Pub. No.: US 2026/0341843 A1
(43) Pub. Date: Oct. 29, 2026

(54) BATTERY MODULE

(71) Applicant: SK On Co., Ltd., Seoul (KR)

(72) Inventors: Hyo Seong AN, Daejeon (KR); Jeong Won KIM, Daejeon (KR); Yun Joo NOH, Daejeon (KR); Hoe Wook CHOI, Daejeon (KR); Dae Gyun HWANG, Daejeon (KR)

(21) Appl. No.: 19/657,011

(22) Filed: Apr. 24, 2026

(30) Foreign Application Priority Data
Apr. 24, 2025 (KR) 10-2025-0053735

(51) Int. Cl. H01M 10/6568; H01M 10/613; H01M 10/653; H01M 10/6556; H01M 50/204; H01M 50/271; H01M 50/291; H01M 50/293

(52) U.S. Cl. CPC H01M 10/6568; H01M 10/613; H01M 10/653; H01M 10/6556; H01M 50/204; H01M 50/271; H01M 50/291; H01M 50/293

(57) ABSTRACT

A battery module includes: a housing having an internal space formed therein and having an inlet through which a refrigerant is introduced and an outlet through which the refrigerant is discharged; a battery cell stack which is accommodated in the housing and in which a plurality of battery cells are stacked in a predetermined stacking direction; and a plurality of first supports formed to protrude from a bottom surface of the housing and supporting the battery cell stack.

### CROSS-REFERENCE TO RELATED PATENT APPLICATION

This patent application claims priority under 35 U.S.C. § 119(a) to Korean patent application number 10-2025-0053735, filed on Apr. 24, 2025, the entire disclosure of which is incorporated herein by reference.

### BACKGROUND

### 1. Field

Various embodiments of the present disclosure generally relate to a battery module.

### 2. Description of Related Art

As the price of energy sources increases due to the depletion of fossil fuels and interest in environmental pollution grows, the demand for eco-friendly alternative energy sources is becoming an indispensable factor for future life. Particularly, along with the technological development and the increasing demand for mobile devices, the demand for secondary batteries as an energy source is rapidly increasing.

For example, when secondary batteries are primarily used in mobile devices, one or two to four battery cells may suffice to achieve the storage capacity and power output levels required by each device. However, because medium-to-large devices such as automobiles require a high-power, high-capacity storage device, using a limited number of cells as described above can cause substantial problems in terms of both energy storage capacity and power output.

Therefore, medium-to-large devices are typically equipped with a battery module in which a plurality of battery cells are electrically connected, or a battery pack including a plurality of such battery modules.

For example, the battery module may include a battery assembly in which a plurality of battery cells are stacked, a module frame for protecting the battery assembly from external impact, heat, or vibration, and end plates covering front and/or rear surfaces of the battery assembly.

For example, the battery module may have a sealed structure through the coupling of the module frame and the end plates; however, an opening may be provided in the end plate to connect an internal member and an external member of the battery module.

Within the battery module, the internal pressure of the battery cells may increase due to overcharging or the like, and high-temperature, gas, or flame may be discharged to the outside of the battery cells, resulting in thermal propagation between the battery cells and successive ignition among the battery cells.

Because such thermal propagation and ignition degrade the durability and safety of the battery module, there is a need to develop a battery module capable of preventing thermal propagation and ignition within the battery module.

### SUMMARY

An embodiment of the present disclosure provides a battery module capable of suppressing or reducing thermal propagation in a secondary battery.

An embodiment of the present disclosure provides a battery module comprising a refrigerant cooling structure configured to suppress thermal propagation between battery cells.

Another embodiment of the present disclosure provides a battery module capable of preventing or mitigating ignition of the secondary battery.

Yet another embodiment of the present disclosure provides a battery module having a structure capable of improving the process efficiency in a manufacturing process of the secondary battery.

A secondary battery module according to the present disclosure can be widely applied in green technology applications such as electric vehicles, battery charging stations, energy storage systems (ESSs), and other technologies using batteries such as photovoltaics and wind power.

Furthermore, the secondary battery module according to the present disclosure may be used for eco-friendly mobility, including electric and hybrid vehicles, to reduce air pollution and greenhouse gas emissions to prevent or mitigate climate change.

An embodiment of the present disclosure may provide a battery module including a housing having an internal space formed therein and having an inlet through which a refrigerant is introduced and an outlet through which the refrigerant is discharged; a battery cell stack which is accommodated in the housing and in which a plurality of battery cells are stacked in a predetermined stacking direction; and a plurality of first supports formed to protrude from a bottom surface of the housing and supporting the battery cell stack.

In an embodiment of the present disclosure, the battery cell stack may be disposed to be spaced apart from the bottom surface of the housing.

In an embodiment of the present disclosure, a thermal interface material may be applied to the plurality of first supports.

In an embodiment of the present disclosure, the plurality of first supports may be disposed spaced apart from each other, and the housing may further comprise spaces between adjacent first supports forming a refrigerant flow path.

In an embodiment of the present disclosure, the battery module may further include a first mesh plate interposed between the plurality of first supports and the battery cell stack.

In an embodiment of the present disclosure, the first mesh plate may include a plurality of mesh holes and a plurality of grid portions disposed between adjacent mesh holes of the plurality of mesh holes.

In an embodiment of the present disclosure, each of the plurality of mesh holes may be filled with the refrigerant.

In an embodiment of the present disclosure, the plurality of first supports may be a plurality of circular projections, and the plurality of circular projections may support the plurality of grid portions.

In an embodiment of the present disclosure, the plurality of first supports may be a plurality of ribs.

In an embodiment of the present disclosure, each of the plurality of ribs may extend in a direction parallel to the stacking direction, and the plurality of ribs may be disposed parallel to each other.

In an embodiment of the present disclosure, the housing may include a first sidewall extending upright from the bottom surface of the housing and parallel to the stacking direction; a second sidewall extending upright from the bottom surface of the housing and parallel to and facing the first sidewall; a third sidewall extending upright from the bottom surface of the housing, disposed in a direction perpendicular to the stacking direction, and connected to the first sidewall and the second sidewall; and a fourth sidewall extending upright from the bottom surface of the housing, disposed parallel to and facing the third sidewall, and connected to the first sidewall and the second sidewall.

In an embodiment of the present disclosure, one of the inlet and the outlet may be formed in the first sidewall, and the other of the inlet and the outlet may be formed in the second sidewall.

In an embodiment of the present disclosure, the plurality of ribs may include a plurality of first ribs, each of which has a first end which terminates at a point where the bottom surface of the housing and the third sidewall are connected, and a second end opposite to the first end; and a plurality of second ribs, each of which has a third end which terminates at a point where the bottom surface of the housing and the fourth sidewall are connected, and a fourth end opposite to the third end. The plurality of first ribs and the plurality of second ribs may be arranged such that the first ribs and the second ribs are arranged alternately with each other in sequence.

In an embodiment of the present disclosure, the second end of the first ribs and the fourth end of second ribs may have a shape of a rounded chamfer.

In another embodiment of the present disclosure, one or more of the inlet and the outlet may be disposed around the first end of the first rib or the third end of the second rib.

In an embodiment of the present disclosure, the housing may have a shape in which an upper region is open, and the battery module may further include an upper cover coupled to the housing and covering the upper region of the housing.

In an embodiment of the present disclosure, a surface pressure pad may be interposed between the upper cover and the battery cell stack.

In an embodiment of the present disclosure, the surface pressure pad may include a plurality of protrusions protruding in a direction toward the battery cell stack.

In another embodiment of the present disclosure, the upper cover may include a plurality of second supports configured to protrude from a bottom surface of the upper cover and support the battery cell stack.

In another embodiment of the present disclosure, the battery module may further include a second mesh plate interposed between the plurality of second supports and the battery cell stack.

According to an embodiment of the present disclosure, thermal propagation in a secondary battery may be suppressed or reduced.

According to another embodiment of the present disclosure, ignition of the secondary battery may be prevented or mitigated.

According to still another embodiment of the present disclosure, the process efficiency in a manufacturing process of the secondary battery may be improved.

### BRIEF DESCRIPTION OF THE DRAWINGS

FIG. 1 is an exploded perspective view schematically illustrating a battery module according to an embodiment of the present disclosure;

FIG. 2 is a schematic view illustrating a side surface of a battery module according to an embodiment of the present disclosure;

FIG. 3 is a schematic view illustrating a flow of a refrigerant at a bottom surface of a housing according to an embodiment of the present disclosure;

FIG. 4 is an exploded perspective view schematically illustrating a battery module according to another embodiment of the present disclosure;

FIG. 5 is a schematic view illustrating a front surface of a battery module according to another embodiment of the present disclosure;

FIG. 6 is a schematic view illustrating a side surface of a battery module according to another embodiment of the present disclosure;

FIGS. 7A and 7B illustrate housing components and a flow of a refrigerant at a bottom surface of the housing according to another embodiment of the present disclosure;

FIG. 8 is an exploded perspective view schematically illustrating a battery module according to still another embodiment of the present disclosure;

FIG. 9 is a schematic view illustrating a flow of a refrigerant at a bottom surface of a housing according to still another embodiment of the present disclosure;

FIG. 10 is a schematic view illustrating a flow of a refrigerant according to positions of an inlet and an outlet according to still another embodiment of the present disclosure;

FIG. 11 is a schematic view of a battery module according to an embodiment of the present disclosure, as viewed from below;

FIG. 12 is a schematic view of a surface pressure pad according to an embodiment of the present disclosure; and

FIG. 13 is a schematic view of a plurality of second supports and a second mesh plate according to another embodiment of the present disclosure.

### DETAILED DESCRIPTION

Hereinafter, embodiments of the present disclosure will be described in detail with reference to the accompanying drawings so that those skilled in the art to which the present disclosure pertains can easily implement the same. However, the embodiments of the present disclosure may be implemented in various different forms and are not limited to the embodiments described herein. In the drawings, parts irrelevant to the description are omitted to clearly describe the embodiments of the present disclosure, and like reference numerals are assigned to like parts throughout this disclosure.

As used herein, the term "secondary battery" refers to a battery cell or a cell, which may include an electrode assembly structure of a cathode plate/separator/anode plate structure stacked in a laminate sheet casing, and the electrode assembly may be embedded in a state of being connected to electrodes formed outside the electrode assembly. Furthermore, the electrodes may lead out to the outside of the sheet and extend in the same direction or opposite directions from each other.

Further, as used herein, the term “secondary battery” encompasses a rechargeable battery, a battery cell, a cell, or a battery.

Furthermore, a secondary battery in the present disclosure may include cylindrical, prismatic, and pouch batteries, depending on the type of a casing.

Further, as used herein, a battery assembly is a collective term for a battery module or battery pack. Thus, a battery assembly according to an embodiment of the present disclosure may refer to a battery module as well as a battery pack that accommodates battery cells without a battery module, such as a cell-to-pack structure (hereinafter referred to as “CTP”).

Furthermore, as used herein, a battery cell refers to a basic unit of a lithium-secondary battery, and more specifically, a lithium-ion battery, that may be charged and discharged with electric energy. For example, main components of a battery cell are a cathode electrode, an anode electrode, a separator, and an electrolyte, and these main components are housed in a case (or pouch) to form the battery cell. The battery cell may further include tabs that are respectively connected to the cathode electrode and the anode electrode for electrical connection to the outside, and that protrude toward the outside of the pouch.

Further, as used herein, a battery module may refer to a battery assembly including one or more of the above-described battery cells grouped and housed in a case to protect the battery cells from external impact, heat, vibration, and the like. The one or more battery cells described above may supply or receive electricity to or from an external source via a busbar assembly, which includes busbars and a busbar frame and is electrically connected to the battery cells.

Further, a battery pack may also refer to a set in which a predetermined number of battery modules are grouped and electrically connected to provide a finally desired voltage or power.

Hereinafter, a battery module 1 according to various embodiments of the present disclosure is described in more detail with the accompanying drawings.

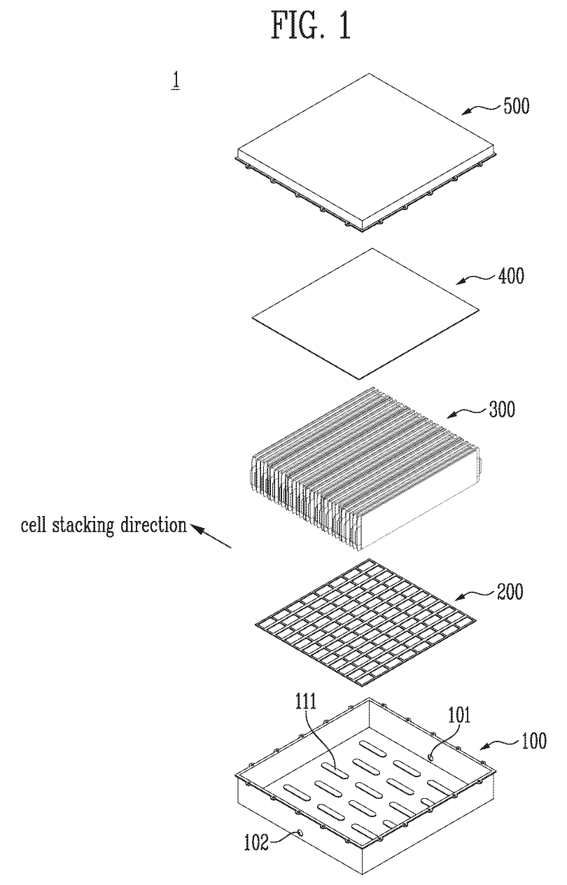

FIG. 1 is an exploded perspective view schematically illustrating the battery module 1 according to an embodiment of the present disclosure.

In an embodiment of the present disclosure, the battery module 1 may include a housing 100 having an internal space formed therein and having an inlet 101 through which a refrigerant is introduced and an outlet 102 through which the refrigerant is discharged; a battery cell stack 300 which is accommodated in the housing 100 and in which a plurality of battery cells 310 are stacked in a predetermined stacking direction; and a plurality of first supports 111 may be projections formed to protrude from a bottom surface 110 of the housing 100 and support the battery cell stack 300.

For example, the battery module 1 may include the battery cell stack 300 in which the plurality of battery cells 310 are stacked and a busbar assembly (not shown) electrically connecting the plurality of battery cells 310 of the battery cell stack 300. Further, the busbar assembly may include a busbar electrically connected to electrodes of the battery cell stack 300 and a busbar frame on which the busbar is mounted.

For example, the plurality of battery cells 310 may be assembled in a stacked configuration and may be electrically connected to one another by a bus bar assembly. The bus bar assembly may be electrically connected to an external device such that electrical energy may be stored in or charged into the battery cell stack 300, or electrical energy stored in the battery cell stack 300 may be supplied to or discharged to the external device.

As shown in FIG. 1, the housing 100 in which the battery cell stack 300 is accommodated has the internal space formed therein, and the internal space may be filled with a refrigerant.

In an embodiment of the present disclosure, to implement effective cooling of the battery cell stack 300, an immersion cooling method may be employed, in which a refrigerant, which is an electrically insulating cooling fluid, is supplied into the inside of the battery module 1 and the refrigerant directly contacts the battery cell stack 300. Thus, by directly cooling the battery cell stack 300 with a refrigerant that has better thermal conductivity than gas, the battery module 1 may be cooled more effectively and fire may be prevented or mitigated.

As shown in FIG. 1, the housing 100 may have the inlet 101 through which the refrigerant is introduced and the outlet 102 through which the refrigerant is discharged. The refrigerant inlet 101 may be coupled to penetrate the housing 100 and may serve as a fluid passage for supplying a refrigerant supplied from an inlet pipe (not shown) from the outside of the housing 100 to the inside of the housing 100. The refrigerant outlet 102 may be coupled to penetrate the housing 100 and may serve as a fluid passage for discharging a refrigerant from the inside of the housing 100 to the outside of the housing 100 to an outlet pipe (not shown) during normal operation of the battery module 1.

Accordingly, because the refrigerant is supplied through the inlet 101 of the housing 100 and is discharged through the outlet 102 of the housing 100, the refrigerant may circulate in the internal space of the housing 100. Thus, the temperature gradient of the refrigerant inside the housing 100 may be reduced, which may result in more uniform cooling of the entire battery cell stack 300.

Heat may be generated during the energy storage process of the battery module 1, which may increase the temperature of the refrigerant via a thermal interface material 600. In addition, the volume of the refrigerant may increase, or the refrigerant may evaporate. Accordingly, a temperature sensor (not shown) may be installed inside the housing 100 to measure the temperature of the refrigerant stored therein. A pressure sensor (not shown) may also be installed to measure pressure changes in the housing 100.

For example, when an air layer is formed in the upper portion of the inside of the housing 100, the pressure sensor may measure pressure changes in the air layer. Also, when the housing 100 is completely filled with a refrigerant, the pressure sensor may measure pressure changes of the refrigerant according to changes in temperature of the refrigerant.

Furthermore, a separate circulation pump (not shown) may be installed in the paths of the inlet and outlet pipes to facilitate more efficient supply and discharge of the refrigerant through the inlet and outlet pipes.

For example, the refrigerant may directly contact the battery cell stack 300 and cool the battery cell stack 300, thereby preventing or mitigating thermal runaway of the battery cells 310 and fire resulting therefrom. For example, the refrigerant may be a fluid with excellent insulating properties and thermal conductivity, and may include hydrofluoroether, fluoro ketone, a perfluorinated compound, or a combination thereof. The type of refrigerant is not limited thereto, and any solution having insulating properties and high thermal conductivity may be employed.

In an embodiment of the present disclosure, the housing 100 may have a shape in which an upper region is open and the battery module 1 may further include an upper cover 500 coupled to the housing 100 and covering the upper region of the housing 100.

As shown in FIG. 1, the upper cover 500 may serve as a cover for the housing 100 having an open shape with an open upper region. Thus, the upper cover 500 may serve as a protective plate to prevent or mitigate a refrigerant from overflowing to the outside of the housing 100.

In an embodiment of the present disclosure, a surface pressure pad 400 may be interposed between the upper cover 500 and the battery cell stack 300.

As shown in FIG. 1, the battery module 1 may include the surface pressure pad 400 disposed between the housing 100 and an upper cover surface 510 of the upper cover 500. For example, the surface pressure pad 400 may be made of a polymer having elastic properties. Thus, the surface pressure pad 400 may exert pressure on the battery cell stack 300 between the housing 100 and the upper cover 500 to prevent or mitigate movement of the battery cell stack 300.

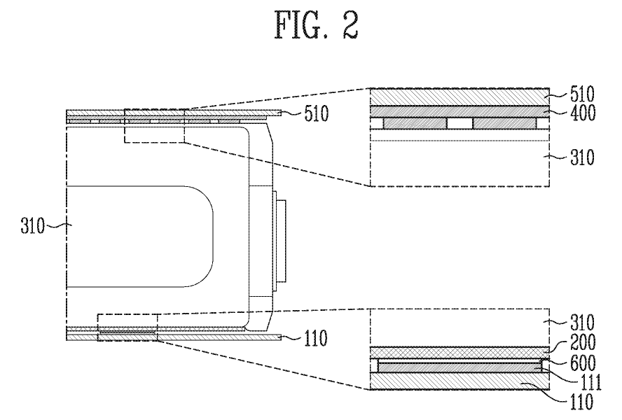

FIG. 2 is a schematic view illustrating a side surface of the battery module 1 according to an embodiment of the present disclosure.

In an embodiment of the present disclosure, via the plurality of first supports 111 supporting the battery cell stack 300, the battery cell stack 300 may be disposed spaced apart from the bottom surface 110 of the housing 100, and the thermal interface material 600 may be applied to upper portions of the plurality of first supports 111.

As shown in FIGS. 1 and 2, the plurality of first supports 111 which support the battery cell stack 300 may be formed on the bottom surface 110 of the housing 100. For example, the plurality of first supports 111 may be integrally formed with the housing 100, or the plurality of first supports 111 may be attached to the housing 100 as separate parts through welding, an adhesive, or the like.

For example, the bottom surface 110 of the housing 100 may be in the form of a flat plate and may be formed of a rectangular plate. For example, the plurality of first supports 111 may be projections protruding from the bottom surface 110 of the housing 100.

For example, the plurality of projections may protrude from the bottom surface 110 of the housing 100 toward the battery cell stack 300. Further, each of the plurality of projections may protrude to have the same height. Thus, the battery cell stack 300 placed on upper portions of the plurality of projections may be prevented or mitigated from being tilted, and the battery cell stack 300 placed on any projection having a different height may be prevented or mitigated from moving.

As shown in FIG. 2, the thermal interface material 600 may be applied to the upper portions of the plurality of first supports 111. For example, the thermal interface material 600 may be a thermally conductive adhesive in the form of one selected from a liquid, a sol, and a gel.

For example, the thermal interface material 600 may include at least one, or a mixture of two or more, selected from: a polymer/metal composite material prepared by mixing a polymer with a metal, such as Al, Ag, Cu, Ni, or the like; a ceramic composite material, such as AlN, Al₂O₃, BN, SiC, BeO, or the like; or a carbon composite material, such as graphite, carbon nanotubes, carbon fibers, graphene, or the like.

For example, a lower end of the battery cell stack 300 placed on the upper portions of the plurality of first supports 111 may come into contact with the thermal interface material 600 applied to the upper portions of the first supports 111 at an initial stage of the placement of the battery cell stack 300, and may be firmly fixed as the thermal interface material 600 cures after a predetermined period of time has elapsed since the placement of the battery cell stack 300. The thermal interface material 600 may form a heat transfer path through which heat generated in the battery cell stack 300 is discharged through the lower end of the battery cell stack 300. Further, the lower end of the battery cell stack 300 may be fixed, thereby reducing damage caused by vibration or impact applied to the battery cell stack 300. Furthermore, the thermal interface material 600 may fill voids between the lower end of the battery cell stack 300 and the plurality of first supports 111, thereby reducing thermal contact resistance while enhancing contact force.

In addition, as shown in FIG. 2, a first mesh plate 200 may be disposed below the battery cell stack 300. The thermal interface material 600 may directly contact the first mesh plate 200. Similar to the contact between the thermal interface material 600 and the battery cell stack 300 described above, the first mesh plate 200 may contact the thermal interface material 600 so that the thermal interface material 600 may form a heat transfer path between the first mesh plate 200 and the plurality of first supports 111, and may fix the first mesh plate 200 to prevent or mitigate the movement of the first mesh plate 200.

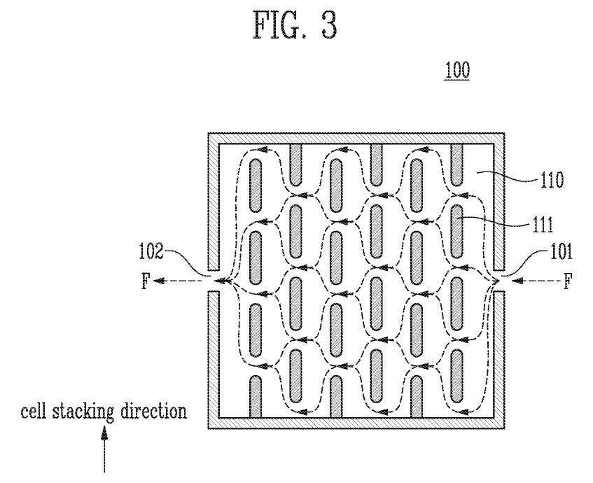

FIG. 3 is a schematic view illustrating a flow of a refrigerant at the bottom surface 110 of the housing 100 according to an embodiment of the present disclosure.

In an embodiment of the present disclosure, the plurality of first supports 111 may be a plurality of ribs, each of the plurality of ribs may extend in a direction perpendicular to the stacking direction, and the ribs may be disposed parallel to each other.

As shown in FIG. 3, because the plurality of first supports 111 extend in a direction perpendicular to the stacking direction of the battery cells 310, a single battery cell 310 may be supported by the plurality of first supports 111 together.

In addition, because the respective ribs are spaced apart from each other while being disposed parallel to each other, a flow path through which the refrigerant can flow may be formed between the adjacent ribs. Accordingly, a flow rate of the refrigerant may become uniform and the cooling efficiency may be improved.

Furthermore, a direction from the refrigerant inlet 101 to the refrigerant outlet 102 and a direction in which the ribs extend may be perpendicular to each other. Thus, the ribs may function as barrier walls that block a flow of the refrigerant at a plurality of points, thereby guiding the flow of the refrigerant so that the refrigerant may flow throughout the bottom surface 110 of the housing 100 from when the refrigerant is introduced through the refrigerant inlet 101 until the refrigerant is discharged through the refrigerant outlet 102. Thus, because the lower end of the battery cell stack 300 may be cooled as a whole, the cooling efficiency of the battery cell stack 300 may be significantly improved and waste of the refrigerant may be prevented or mitigated.

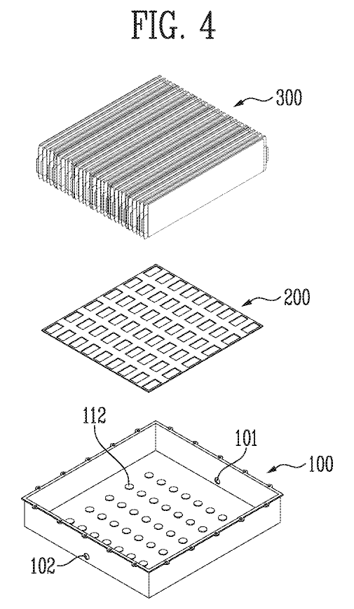

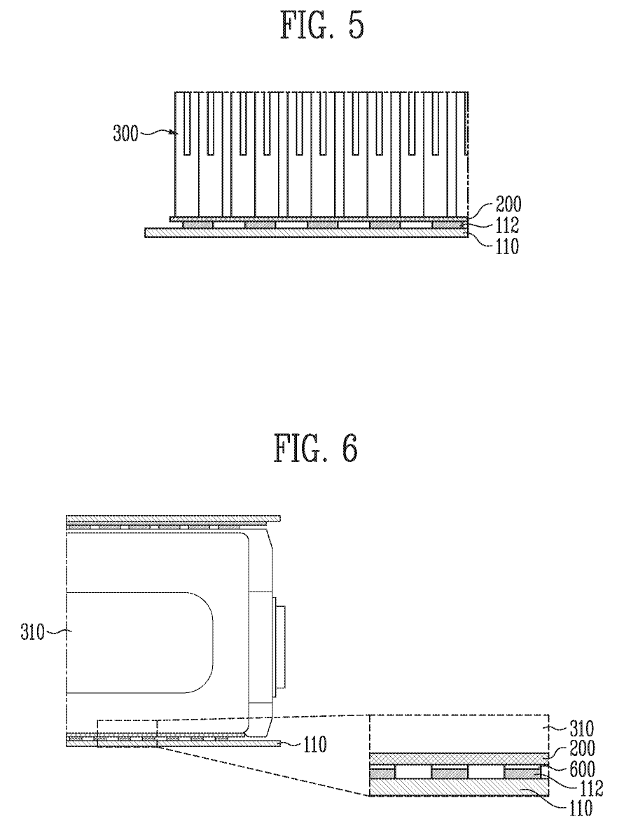

FIG. 4 is an exploded perspective view schematically illustrating the battery module 1 according to another embodiment of the present disclosure, and FIG. 5 is a schematic view illustrating a front surface of the battery module 1 according to another embodiment of the present disclosure.

According to another embodiment of the present disclosure, the first mesh plate 200 interposed between the first support 111 and the battery cell stack 300 may be further included. Further, the first mesh plate 200 may include a plurality of mesh holes 210 and a plurality of grid portions 220 disposed between the mesh holes 210. Each of the plurality of mesh holes 210 may be filled with the refrigerant. In another embodiment of the present disclosure, the first supports may be circular projections 112, and the circular projections 112 may support the plurality of grid portions 220.

For example, as shown in FIGS. 4 and 5, the first mesh plate 200 may directly contact the battery cell stack 300 and each of the plurality of first supports 112 and may be positioned between the battery cell stack 300 and the plurality of first supports 112. Specifically, an upper surface of the first mesh plate 200 may directly contact the battery cell stack 300, and a lower surface of the first mesh plate 200 may directly contact the plurality of first supports 112.

For example, the first mesh plate 200 may include a metal material to ensure rigidity. For example, the first mesh plate 200 may include an aluminum material to ensure rigidity while also reducing the weight of the entire battery module 1. However, the material is not limited thereto, and the first mesh plate 200 may also include a plastic material as long as the first mesh plate 200 has predetermined rigidity capable of supporting the battery cell stack 300. For example, when the first mesh plate 200 includes a metal material, an insulating coating may be provided on the upper surface of the first mesh plate 200 to prevent or mitigate a short circuit with the battery cell stack 300.

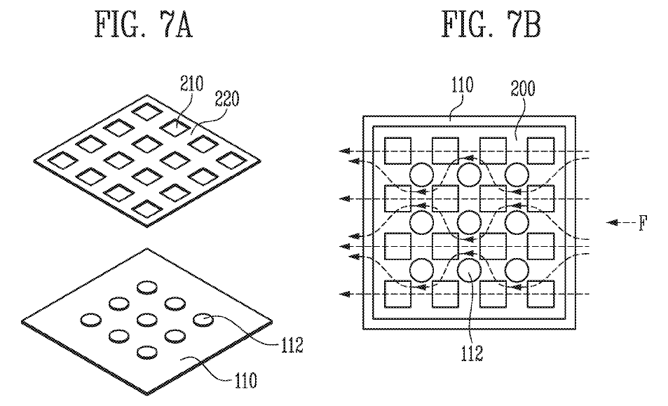

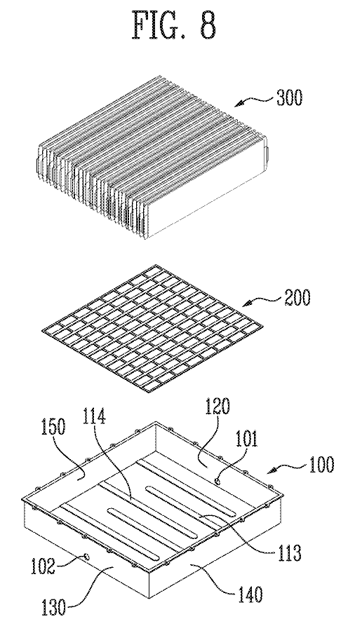

FIG. 6 is a schematic view illustrating a side surface of the battery module 1 according to another embodiment of the present disclosure, and FIGS. 7A and 7B illustrate housing components and a flow of a refrigerant at the bottom surface 110 of the housing 100 according to another embodiment of the present disclosure.

As shown in FIGS. 6, 7A and 7B, the first mesh plate 200 may include the mesh holes 210. The mesh holes 210 are provided to minimize contact resistance of the first mesh plate 200 upon contact with the battery cell stack 300, and may be disposed between the bottom surface 110 of the housing 100 and the battery cell stack 300.

For example, the mesh hole 210 may have a quadrilateral shape. For example, the mesh hole 210 may have a circular shape. However, a shape of the mesh hole 210 is not limited thereto, and the shape of the mesh hole 210 may be formed in a honeycomb shape, various polygonal shapes, an elliptical shape, or the like, having a mesh structure capable of minimizing or reducing the contact resistance of the first mesh plate 200.

For example, the mesh holes 210 may be filled with the refrigerant. Accordingly, the refrigerant may be filled in the mesh holes 210 such that the refrigerant directly contacts the battery cell stack 300. The refrigerant filled in the mesh holes 210 may be disposed in the same plane as the mesh plate. Thus, the efficiency of the thermal interface material 600 of the battery cell stack 300 may be further improved.

As shown in FIGS. 7A and 7B, the first mesh plate 200 may include the grid portion 220 at a portion where rigid reinforcement bars around the mesh hole 210 overlap. The rigid reinforcement bar may be included in the first mesh plate 200 and may include a plurality of reinforcement bars spaced apart from each other at a predetermined distance to partition the mesh holes 210. For example, the grid portion 220 may be disposed in the same plane as the first mesh plate 200, thereby directly contacting the battery cell stack 300 on an upper surface of the grid portion 220, along with the refrigerant that is filled in the mesh hole 210. Furthermore, a bottom surface of the grid portion 220 may directly contact a circular projection protruding from the bottom surface 110 of the housing 100.

For example, heat generated in the battery cell stack 300 may be first transferred to the first mesh plate 200, which is disposed to contact a lower surface of the battery cell stack 300. Further, the heat transferred to the first mesh plate 200 may be directly transferred to the refrigerant filled in the mesh holes 210 or the refrigerant flowing between the lower surface of the first mesh plate 200 and the bottom surface 110 of the housing 100. Accordingly, the heat generated in the battery cell stack 300 may be transferred directly to the refrigerant.

Furthermore, as shown in FIG. 6, the thermal interface material 600 may also be applied to upper surfaces of the circular projections 112, thereby further ensuring contact force between the first mesh plate 200 and the circular projections 112.

Furthermore, as shown in FIGS. 7A and 7B, because the refrigerant may flow into spaces between the circular projections 112, the flow of the refrigerant at the lower surface of the first mesh plate 200 may be ensured, thereby improving the cooling performance of the battery module 1.

That is, while the first mesh plate 200 and the circular projections 112 support the lower surface of the battery cell stack 300, a predetermined space may be ensured between the battery cell stack 300 and the bottom surface 110 of the housing 100. Thus, a structure that allows the refrigerant to flow into the predetermined space may be applied. Accordingly, the manufacturing time and manufacturing cost of the battery module 1 may be reduced, while the cooling performance of the battery module 1 may be improved.

FIG. 8 is an exploded perspective view schematically illustrating the battery module 1 according to still another embodiment of the present disclosure.

In an embodiment of the present disclosure, the housing 100 may include: a first sidewall 120 extending upright from the bottom surface 110 of the housing 100 and parallel to a stacking direction of the battery cell stack 300; a second sidewall 130 extending upright from the bottom surface 110 of the housing 100 and parallel to and facing the first sidewall 120; a third sidewall 140 extending upright from the bottom surface 110 of the housing 100, disposed in a direction perpendicular to the stacking direction of the battery cell stack 300, and connected to the first sidewall 120 and the second sidewall 130; and a fourth sidewall 150 extending upright from the bottom surface 110 of the housing 100, disposed parallel to and facing the third sidewall 140, and connected to the first sidewall 120 and the second sidewall 130.

As shown in FIG. 8, the walls forming side surfaces of the housing 100, which accommodates the battery cell stack 300 with the first mesh plate 200 interposed between the housing 100 and the battery cell stack 300, may include the first sidewall 120, the second sidewall 130, the third sidewall 140, and the fourth sidewall 150. For example, the first sidewall 120 to the fourth sidewall 150 may be disposed upright from the bottom surface 110 of the housing 100. For example, the first sidewall 120 and the second sidewall 130 may be disposed parallel to each other, and the third sidewall 140 and the fourth sidewall 150 may be disposed parallel to each other. In addition, the first sidewall 120 may be disposed perpendicular to the third sidewall 140 and the fourth sidewall 150. Further, the second sidewall 130 may be disposed perpendicular to the third sidewall 140 and the fourth sidewall 150. Thus, the first sidewall 120 to the fourth sidewall 150 forming the side surfaces of the housing 100 may be disposed in a rectangular configuration.

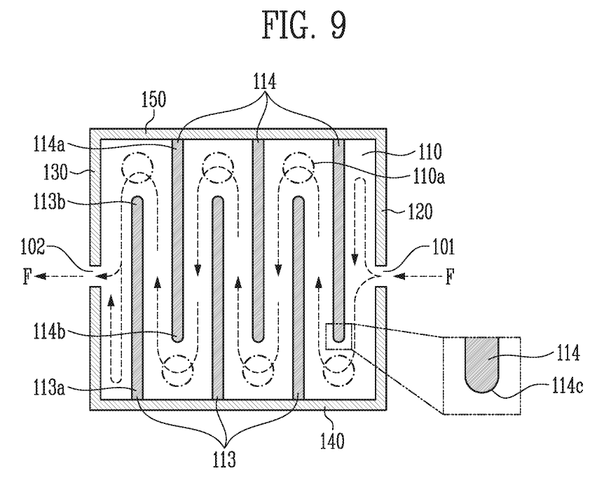

FIG. 9 is a schematic view illustrating a flow of a refrigerant at the bottom surface 110 of the housing 100 according to still another embodiment of the present disclosure.

In still another embodiment of the present disclosure, one of the refrigerant inlet 101 and the refrigerant outlet 102 may be formed in the first sidewall 120, and the other of the refrigerant inlet 101 and the refrigerant outlet 102 may be formed in the second sidewall 130. Further, in an embodiment of the present disclosure, the plurality of ribs may include a plurality of first ribs 113, each of which has a first end 113a which terminates at a point where the bottom surface 110 of the housing 100 and the third sidewall 140 are connected, and a second end 113b. Further, the plurality of ribs may include a plurality of second ribs 114, each of which has a third end 114a which terminates at a point where the bottom surface 110 of the housing 100 and the fourth sidewall 150 are connected, and a fourth end 114b. Further, the plurality of first ribs 113 and the plurality of second ribs 114 may be arranged such that the first ribs 113 and the second ribs 114 are arranged alternately with each other in sequence.

As shown in FIG. 9, the first end 113a of the first rib 113 may terminate in an edge region of the bottom surface 110 of the housing 100 to which the third sidewall 140 is connected, and the second end 113b of the first rib 113 may be positioned in one region of the bottom surface 110 of the housing 100. Further, the third end 114a of the second rib 114 may terminate in an edge region of the bottom surface 110 to which the fourth sidewall 150 is connected, and the fourth end 114b of the second rib 114 may be positioned in one region of the bottom surface 110 of the housing 100.

Furthermore, the first rib 113 and the second rib 114 may be arranged alternately with each other in sequence, and may extend to be arranged perpendicular to the direction from the refrigerant inlet 101 to the refrigerant outlet 102. Thus, the first rib 113 and the second rib 114 may function as barrier walls that block a flow of the refrigerant at a plurality of points.

Furthermore, as described above, because the one end 113a of the first rib 113 and the one end 114a of the second rib 114 each terminate in the edge region of the bottom surface 110 of the housing 100, the flow of the refrigerant in a closed region 110a formed around a termination point of each of the one end 113a and the one end 114a may be retained for a predetermined period of time. Thus, until the refrigerant introduced through the refrigerant inlet 101 is discharged through the refrigerant outlet 102, the closed region 110a may guide the flow of the refrigerant so that the refrigerant may sufficiently cool the edge region of the bottom surface 110 of the housing 100. Thus, because the lower end of the battery cell stack 300 may be cooled as a whole, the cooling efficiency of the battery cell stack 300 may be significantly improved and waste of the refrigerant may be prevented or mitigated.

In still another embodiment of the present disclosure, the second end 113b of the first rib 113 and the fourth end 114b of the second rib 114 may have a shape of a rounded chamfer 114c. Specifically, as illustrated in FIG. 9, the shape of the second end 113b and the fourth end 114b may be a shape of the rounded chamfer 114c. For example, compared to a configuration in which an end of a rib has a shape of a right-angled edge, the flow of the refrigerant may be prevented from being interrupted by the end of the rib. Thus, a refrigerant flow F at the lower end of the battery cell stack 300 may be more effectively realized, and thus the cooling efficiency of the battery cell stack 300 may be significantly improved.

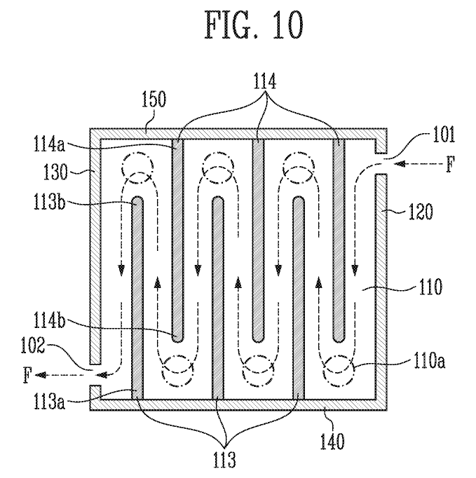

FIG. 10 is a schematic view illustrating a flow of a refrigerant according to positions of the inlet 101 and the outlet 102 according to still another embodiment of the present disclosure.

In still another embodiment of the present disclosure, one or more of the inlet 101 and the outlet 102 may be disposed around the first end 113a of the first rib 113 or around the third end 114a of the second rib 114.

For example, in an embodiment of the present disclosure shown in FIG. 9, a portion of the refrigerant introduced through the inlet 101 may flow after passing through a closed region around the one end 114a of the second rib 114 first encountered by the refrigerant. That is, when only the refrigerant flow is considered, an effect of overlapping flow paths of the refrigerant in the housing may occur.

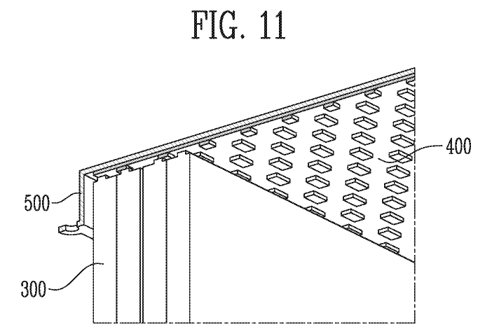

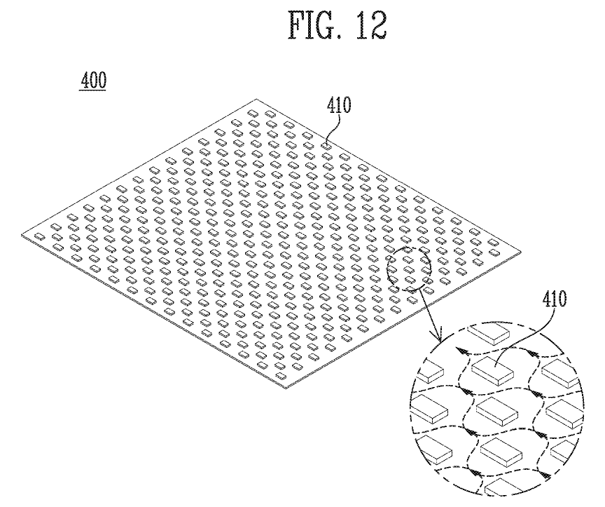

FIG. 11 is a schematic view of the battery module 1 according to an embodiment of the present disclosure, as viewed from below. FIG. 12 is a schematic view of the surface pressure pad 400 according to an embodiment of the present disclosure.

In contrast, in another embodiment of the present disclosure shown in FIG. 10, the inlet 101 and the outlet 102 may be disposed in a closed region around the first end 113a of the first rib 113 or the third end 114a of the second rib 114, i.e., in a closed region. Thus, the flow paths of the refrigerant in the housing do not overlap, and the refrigerant may flow naturally from the inlet 101 to the outlet 102. Furthermore, the flow rate of the refrigerant in the housing may be increased.

In an embodiment of the present disclosure, the surface pressure pad 400 may include a plurality of protrusions 410 that protrude in the direction toward the battery cell stack 300.

As shown in FIGS. 11 and 12, the plurality of protrusions 410 may be provided from a surface of the surface pressure pad 400. For example, the plurality of protrusions 410 may be molded integrally with the surface pressure pad 400, or the plurality of protrusions 410 may be molded by attaching the plurality of separate protrusions 410 to the surface pressure pad 400.

The plurality of protrusions 410 may include a synthetic resin material having a predetermined elastic force, for example, the plurality of protrusions 410 may be made of one material selected from the group consisting of Ethylene Vinyl Acetate (EVA), Ethylene Propylene Diene Monomer (EPDM), Thermo Plastic Elastomer (TPE), Thermoplastic Polyurethane (TPU), Expanded Polypropylene (EPP) to have cushioning properties. Alternatively, the plurality of protrusions 410 may be made of one material selected from the group consisting of a rubber-based group, such as EPDM, a thermoplastic-based group, such as TPE and TPU, and a high-density foamed plastic-based group, such as EPP. Alternatively, the plurality of protrusions 410 may be changed to various materials within a range that satisfies a condition under which the plurality of protrusions 410 has an appropriate elastic force such that the plurality of protrusions 410 is compressed by external pressure and then restored to an original shape thereof upon release of the pressure.

Furthermore, the material of the plurality of protrusions 410 may be selected in consideration of reactivity with the refrigerant that cools the battery cell stack 300 while having a predetermined elastic force. For example, when a hydrocarbon-based mineral oil is selected as the refrigerant, the material of the plurality of protrusions 410 may preferably be a silicone-based or acrylic-based elastic material, because such a refrigerant has poor reactivity with EPDM.

As shown in FIG. 11, the protrusions 410 of the surface pressure pad 400 may press the battery cell stack 300 between the upper cover surface 510 of the upper cover 500 and the battery cell stack 300 to prevent or mitigate movement of the battery cell stack 300. In addition, although not shown, when the first mesh plate 200 described above is also applied to an upper end of the battery cell stack 300, the protrusion 410 of the surface pressure pad 400 may simultaneously press the first mesh plate 200 and the battery cell stack 300 while contacting the first mesh plate 200, thereby preventing or mitigating the movement of the first mesh plate 200 and the battery cell stack 300.

As shown in FIGS. 2 and 12, because the plurality of protrusions 410 is formed spaced apart from each other, a passage through which the refrigerant can flow may be formed between the adjacent protrusions 410. Furthermore, through the plurality of protrusions 410 pressing the battery cell stack 300, the battery cell stack 300 may be spaced apart from the upper cover surface 510 of the upper cover 500.

Thus, because a passage through which the refrigerant can flow is formed in the upper end of the battery cell stack 300, the cooling efficiency of the upper end of the battery cell stack 300 may also be improved, thereby preventing or mitigating waste of the refrigerant.

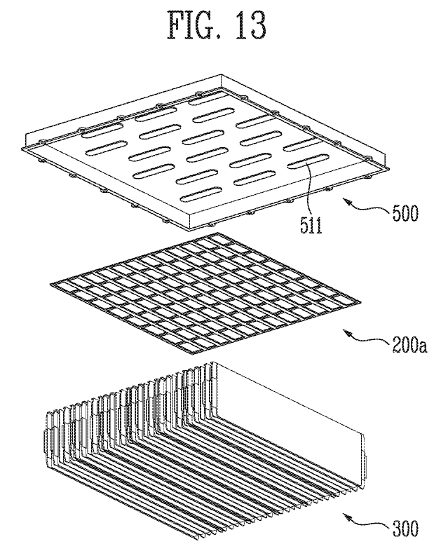

FIG. 13 is a schematic view of a plurality of second supports 511 and a second mesh plate 200a according to another embodiment of the present disclosure.

In another embodiment of the present disclosure, the upper cover 500 may include the plurality of second supports 511 formed to protrude from a bottom surface of the upper cover 500 and supporting the battery cell stack 300.

For example, the plurality of second supports 511 formed on the bottom surface of the upper cover 500 may be projections that protrude from the bottom surface of the upper cover 500. The plurality of projections may support the battery cell stack 300 downward from above the battery cell stack 300. Thus, the battery cell stack 300 may be spaced apart from the bottom surface of the upper cover 500.

As shown in FIG. 13, for example, the plurality of second supports 511 may include a plurality of ribs, and the respective ribs may be spaced apart from each other while being disposed parallel to each other. Thus, because a flow path through which the refrigerant can flow may be formed between the adjacent ribs, a flow rate of the refrigerant may become uniform and the cooling efficiency may be improved.

Although not specifically shown in FIG. 13, the plurality of second supports 511 may have a similar shape, position, arrangement, and material to the first supports 111 described above, and may have a similar action and function to the first supports 111.

In another embodiment of the present disclosure, the second mesh plate 200a may be interposed between the plurality of second supports 511 and the battery cell stack 300.

For example, the second mesh plate 200a may directly contact the battery cell stack 300 and each of the plurality of second supports 511, and may be positioned between the battery cell stack 300 and the plurality of second supports 511. Specifically, an upper surface of the second mesh plate 200a may directly contact the plurality of second supports 511, and a lower surface of the second mesh plate 200a may directly contact the battery cell stack 300.

Although not specifically shown in FIG. 13, the second mesh plate 200a may have a similar shape, position, arrangement, and material to the first mesh plate 200 described above, and may have a similar action and function to the first mesh plate 200.

While the embodiments of the present disclosure have been illustrated and described with respect to specific embodiments and drawings, the disclosed embodiments are not intended to be restrictive. Further, it is noted that the embodiments may be achieved in various ways through substitution, change, and modification, as those skilled in the art will recognize in light of the present disclosure, without departing from the spirit and/or scope of the present disclosure and the following claims. Furthermore, the embodiments may be combined to form additional embodiments.

What is claimed is:

1. A battery module comprising:
a housing having an internal space formed therein and having an inlet through which a refrigerant is introduced and an outlet through which the refrigerant is discharged;
a battery cell stack which is accommodated in the housing and in which a plurality of battery cells are stacked in a predetermined stacking direction; and
a plurality of first supports formed to protrude from a bottom surface of the housing and supporting the battery cell stack.

2. The battery module of claim 1, wherein the battery cell stack is disposed spaced apart from the bottom surface of the housing.

3. The battery module of claim 1, wherein a thermal interface material is applied to the plurality of first supports.

4. The battery module of claim 1, wherein the plurality of first supports are disposed spaced apart from each other, and
wherein the housing further comprises spaces between adjacent first supports forming a refrigerant flow path.

5. The battery module of claim 3, further comprising a first mesh plate interposed between the plurality of first supports and the battery cell stack.

6. The battery module of claim 5, wherein the first mesh plate comprises a plurality of mesh holes and a plurality of grid portions disposed between adjacent mesh holes of the plurality of mesh holes.

7. The battery module of claim 6, wherein each of the plurality of mesh holes is filled with the refrigerant.

8. The battery module of claim 6, wherein the plurality of first supports is a plurality of circular projections, and
wherein the plurality of circular projections supports the plurality of grid portions.

9. The battery module of claim 1, wherein the plurality of first supports is a plurality of ribs.

10. The battery module of claim 9, wherein each of the plurality of ribs extends in a direction parallel to the stacking direction, and the plurality of ribs is disposed parallel to each other.

11. The battery module of claim 10, wherein the housing comprises:
a first sidewall extending upright from the bottom surface of the housing and parallel to the stacking direction;
a second sidewall extending upright from the bottom surface of the housing and parallel to and facing the first sidewall;
a third sidewall extending upright from the bottom surface of the housing, disposed in a direction perpendicular to the stacking direction, and connected to the first sidewall and the second sidewall; and
a fourth sidewall extending upright from the bottom surface of the housing, disposed parallel to and facing the third sidewall, and connected to the first sidewall and the second sidewall.

12. The battery module of claim 11, wherein one of the inlet and the outlet is formed in the first sidewall, and
wherein the other of the inlet and the outlet is formed in the second sidewall.

13. The battery module of claim 12, wherein the plurality of ribs comprises:
a plurality of first ribs, each of which has a first end which terminates at a point where the bottom surface of the housing and the third sidewall are connected, and a second end opposite to the first end; and
a plurality of second ribs, each of which has a third end which terminates at a point where the bottom surface of the housing and the fourth sidewall are connected, and a fourth end opposite to the third end, and
wherein the plurality of first ribs and the plurality of second ribs are arranged such that the first ribs and the second ribs are arranged alternately with each other in sequence.

14. The battery module of claim 13, wherein the second end and the fourth end has a shape of a rounded chamfer.

15. The battery module of claim 13, wherein one or more of the inlet and the outlet are disposed around the first end of the first rib or the third end of the second rib.

16. The battery module of claim 1, wherein the housing has a shape in which an upper region is open, and
wherein the battery module further comprises an upper cover coupled to the housing and covering the upper region of the housing.

17. The battery module of claim 16, wherein a surface pressure pad is interposed between the upper cover and the battery cell stack.

18. The battery module of claim 17, wherein the surface pressure pad comprises a plurality of protrusions protruding in a direction toward the battery cell stack.

19. The battery module of claim 16, wherein the upper cover comprises a plurality of second supports formed to protrude from a bottom surface of the upper cover and supporting the battery cell stack.

20. The battery module of claim 19, further comprising a second mesh plate interposed between the plurality of second supports and the battery cell stack.
